(19) United States
(12) Patent Application Publication
(10) Pub. No.: US 2026/0285772 A1
(43) Pub. Date: Sep. 24, 2026

(54) METHOD FOR PRODUCING CERAMIC PRODUCT

(71) Applicant: NGK INSULATORS, LTD., Nagoya-shi (JP)

(72) Inventors: Daniel Yukichi KITAGUCHI, Inazawa-shi (JP); Yasunobu TANAKA, Nagoya-shi (JP)

(73) Assignee: NGK INSULATORS, LTD., Nagoya-shi (JP)

(21) Appl. No.: 19/550,633

(22) Filed: Feb. 26, 2026

(30) Foreign Application Priority Data
Mar. 19, 2025 (JP) 2025-045687

(51) Int. Cl. C04B 38/00

(52) U.S. Cl. CPC C04B 38/0009; C04B 2235/3206; C04B 2235/3217; C04B 2235/3418

(57) ABSTRACT

A method for producing a ceramic product, the method comprising adjusting a water vapor partial pressure in a firing furnace when firing a subsequent ceramic product using at least one result of a water absorption rate and a compressive strength that are characteristics of a previously fired ceramic product.

### FIELD OF THE INVENTION

This invention relates to a method for producing a ceramic product such as a honeycomb structure.

### BACKGROUND OF THE INVENTION

For example, ceramic products such as honeycomb structures are widely and generally used. For example, honeycomb structures are used in a wide range of applications such as catalyst supports for automotive exhaust gas purification, diesel particulate filters (DPFs), gasoline particulate filters (GPFs), and heat storage bodies for combustion devices. Honeycomb structures are produced by firing a honeycomb formed body. A method is known in which a honeycomb formed body is placed on multi-stage shelves in a firing furnace such as a single kiln or a continuous kiln, and fired at a high temperature using electric or gas energy.

In producing ceramic products industrially, it is required to produce them so as to meet predetermined characteristic standards. Conventionally, adjustment of characteristics of ceramic products is performed by adjustment of raw materials of ceramic products and firing conditions of ceramic products. The following Patent Literatures 1 and 2 disclose controlling the characteristics of ceramic products by adjusting a firing heat curve (displacement of a firing temperature). The following Patent Literature 3 disclose feedback-controlling conditions of a firing furnace based on information obtained by analyzing an exhaust gas from a firing furnace in order to control characteristics of a ceramics fired body.

### CITATION LIST

### Patent Literatures

[Patent Literature 1] WO 2005/068396 A1
[Patent Literature 2] Japanese Patent Application Publication No. 2001-519310 A
[Patent Literature 3] Japanese Patent Application Publication No. H10-274486 A

### SUMMARY OF THE INVENTION

When a ceramic product is incorporated into another configuration as a component, high dimensional accuracy is required for the ceramic product. Although it is possible to control the dimensions of a ceramic product by adjusting the firing temperature because a firing heat curve has a particularly large effect on variation in a firing shrinkage rate, depending on raw materials of the ceramic product, the product is sensitive to, for example, a maximum temperature during firing, and an adjustment latitude may be small. Further, in the case of adjustment in a direction of increasing a maximum temperature during firing, problems such as deformation, discoloration, or melting of the ceramic product may occur.

This invention has been made to solve the above problems, and one of objects thereof is to provide a method for producing a ceramic product that can adjust characteristics of the ceramic product by a parameter different from a firing temperature.

As a result of various studies, the present inventors have obtained new findings that there is a correlation between a water vapor partial pressure in a firing furnace when firing a ceramic product, and a water absorption rate and a compressive strength of the ceramic product, and that at least one of the water absorption rate and the compressive strength of the ceramic product can be adjusted by adjusting the water vapor partial pressure in the firing furnace. This invention has been made on the basis of these new findings.

[1] In an embodiment, this invention relates to a method for producing a ceramic product, the method including adjusting a water vapor partial pressure in a firing furnace when firing a subsequent ceramic product using at least one result of a water absorption rate and a compressive strength that are characteristics of a previously fired ceramic product.

[2] This invention may relate to the method for producing a ceramic product according to aspect 1, further including a step of obtaining, from the at least one result, at least one relational expression of a relational expression between the water absorption rate and the water vapor partial pressure and a relational expression between the compressive strength and the water vapor partial pressure, wherein the water vapor partial pressure in the firing furnace when firing the subsequent ceramic product is adjusted using the at least one relational expression.

[3] This invention may relate to the method for producing a ceramic product according to aspect 2, wherein the at least one relational expression is obtained for each material of the ceramic product.

[4] This invention may relate to the method for producing a ceramic product according to aspect 2 or 3, wherein, when a material of the ceramic product is an oxide-based material, and the water absorption rate is Y and the water vapor partial pressure is X, a relational expression between the water absorption rate and the water vapor partial pressure is as follows:

$$Y = - c * X + d ,$$

in which c and d are variables determined by a composition of the oxide-based material.

[5] This invention may relate to the method for producing a ceramic product according to any one of aspects 2 to 4, wherein, when a material of the ceramic product is an oxide-based material, and the compressive strength is A and the water vapor partial pressure is X, a relational expression between the compressive strength and the water vapor partial pressure is as follows:

$$A = e * X + f ,$$

in which e and f are variables determined by a composition of the oxide-based material.

[6] This invention may relate to the method for producing a ceramic product according to any one of aspects 1 to 5, wherein a water vapor partial pressure in the firing furnace when firing the subsequent ceramic product is 33% or less.

[7] This invention may relate to the method for producing a ceramic product according to any one of aspects 1 to 6, wherein change adjustment of the water vapor partial pressure is performed when a firing temperature in the firing furnace is 600° C. or more and a maximum temperature or less.

[8] This invention may relate to the method for producing a ceramic product according to any one of aspects 1 to 7, wherein a ratio of an organic material in a raw material of the ceramic product is 20% by mass or less.

According to an embodiment of the method for producing the ceramic product of this invention, a water vapor partial pressure in a firing furnace when firing a subsequent ceramic product is adjusted using at least one result of a water absorption rate and a compressive strength that are characteristics of a previously fired ceramic product, so that characteristics of the ceramic product can be adjusted by a parameter different from a firing temperature.

### BRIEF DESCRIPTION OF THE DRAWINGS

FIG. 1 is a perspective view schematically showing a wall-through type pillar shaped honeycomb structure that can be produced by a method for producing a ceramic product according to an embodiment of this invention;

FIG. 2 is a schematic cross-sectional view when the wall-through type pillar shaped honeycomb structure in FIG. 1 is observed from a direction orthogonal to an extending direction of cells;

FIG. 3 is a perspective view schematically showing a wall-flow type pillar shaped honeycomb structure that can be produced by a method for producing a ceramic product according to an embodiment of this invention;

FIG. 4 is a schematic cross-sectional view when the wall-flow type pillar shaped honeycomb structure in FIG. 3 is observed from a direction orthogonal to an extending direction of cells;

FIG. 5 is an explanatory view schematically showing an electric furnace that can be used in a method for producing a ceramic product according to the embodiment;

FIG. 6 is a graph showing a relationship between a water absorption rate and a water vapor partial pressure during firing for a pillar shaped honeycomb structure using material A;

FIG. 7 is a graph showing a relationship between a water absorption rate and a water vapor partial pressure during firing for a pillar shaped honeycomb structure using material B;

FIG. 8 is a graph showing a relationship between a water absorption rate and a water vapor partial pressure during firing for a pillar shaped honeycomb structure using material C;

FIG. 9 is a graph showing a relationship between a compressive strength and a water vapor partial pressure during firing for a pillar shaped honeycomb structure using material A;

FIG. 10 is a graph showing a relationship between a compressive strength and a water vapor partial pressure during firing for a pillar shaped honeycomb structure using material B;

FIG. 11 is a graph showing a relationship between a compressive strength and a water vapor partial pressure during firing for a pillar shaped honeycomb structure using material C;

FIG. 12 is a graph showing a relationship between a firing ratio (dimension) and a water vapor partial pressure during firing for a pillar shaped honeycomb structure using material A;

FIG. 13 is a graph showing a relationship between a firing ratio (dimension) and a water vapor partial pressure during firing for a pillar shaped honeycomb structure using material B;

FIG. 14 is a graph showing a relationship between a firing ratio (dimension) and a water vapor partial pressure during firing for a pillar shaped honeycomb structure using material C;

FIG. 15 is a graph showing a relationship between a porosity and a water vapor partial pressure during firing for a pillar shaped honeycomb structure using material A;

FIG. 16 is a graph showing a relationship between a porosity and a water vapor partial pressure during firing for a pillar shaped honeycomb structure using material B; and

FIG. 17 is a graph showing a relationship between a porosity and a water vapor partial pressure during firing for a pillar shaped honeycomb structure using material C.

### DETAILED DESCRIPTION OF THE INVENTION

Hereinafter, embodiments of the invention will be specifically described with reference to the drawings. The invention is not limited to each embodiment, and components can be modified and embodied without departing from the spirit of the invention. Further, various inventions can be formed by appropriately combining a plurality of components disclosed in each embodiment. For example, some components may be removed from all of the components shown in the embodiments. Furthermore, the components of different embodiments may be optionally combined.

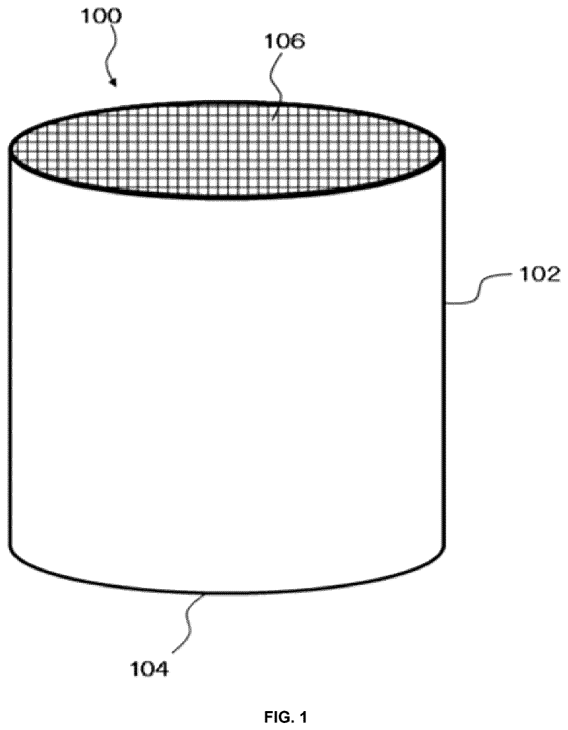

The method for producing the ceramic product according to the embodiment is a method for producing a ceramic product by firing. The ceramic product may be of various types. A pillar shaped honeycomb structure as an example of a ceramic product will be described with reference to FIGS. 1 to 4.

### <1. Pillar Shaped Honeycomb Structure>

In general, a pillar shaped honeycomb structure has a pillar shaped honeycomb structure portion including an outer peripheral side wall and partition walls provided on an inner peripheral side of the outer peripheral side wall, the partition walls defining a plurality of cells that form a flow path from a first end face to a second end face of the pillar shaped honeycomb structure portion.

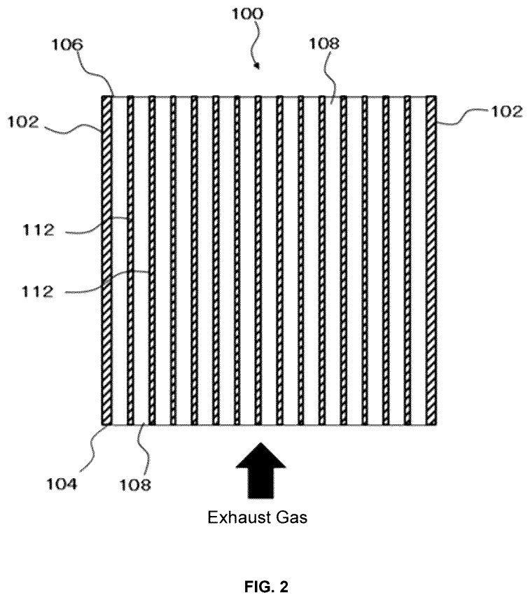

FIGS. 1 and 2 respectively illustrate a schematic perspective view and a cross-sectional view of a pillar shaped honeycomb structure 100 applicable as a wall-through type automotive exhaust gas filter and/or catalyst support. This pillar shaped honeycomb structure 100 has a pillar shaped honeycomb structure portion including an outer peripheral side wall 102 and partition walls 112 provided on an inner peripheral side of the outer peripheral side wall 102, the partition walls 112 defining a plurality of cells 108 that form a flow path of a fluid from a first end face 104 to a second end face 106 of the pillar shaped honeycomb structure portion. In this pillar shaped honeycomb structure 100, both ends of each cell 108 are open, and an exhaust gas that flows into one cell 108 from the first end face 104 is purified while passing through the cell, and flows out from the second end face 106.

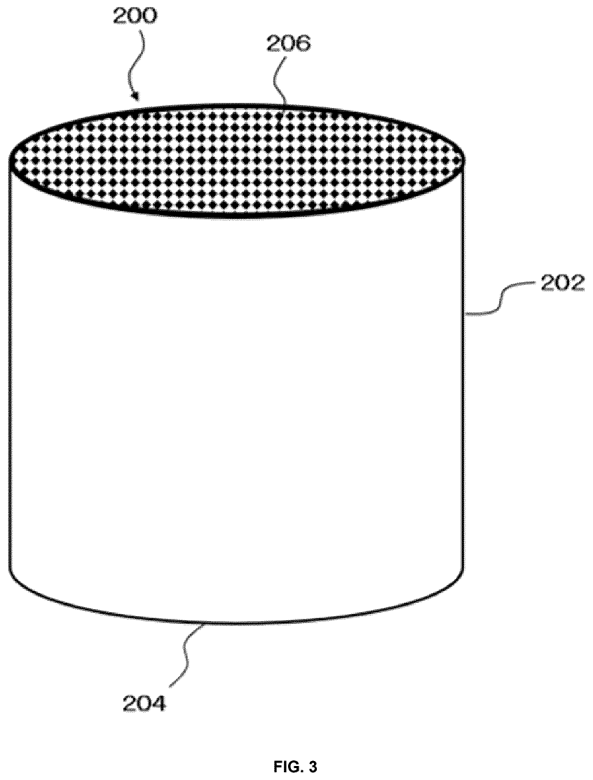

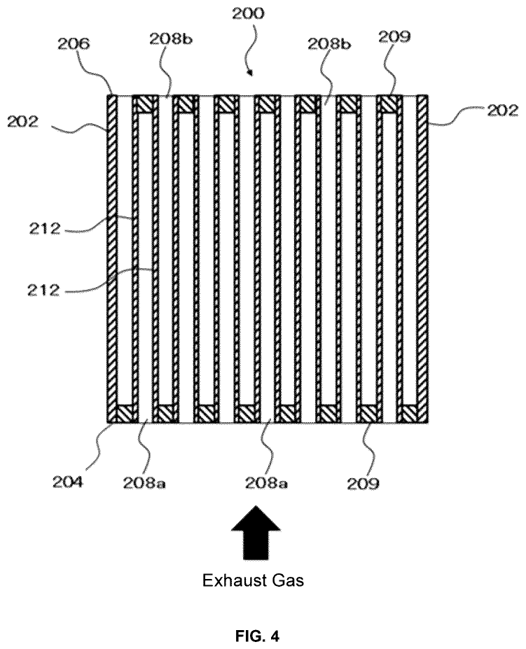

FIGS. 3 and 4 respectively illustrate a schematic perspective view and a cross-sectional view of a pillar shaped honeycomb structure 200 applicable as a wall-flow type automotive exhaust gas filter and/or catalyst support. This pillar shaped honeycomb structure 200 has a pillar shaped honeycomb structure portion including an outer peripheral side wall 202 and partition walls 212 provided on an inner peripheral side of the outer peripheral side wall 202, the partition walls 212 defining and forming a plurality of cells 208a, 208b that form a flow path of a fluid from a first end face 204 to a second end face 206 of the pillar shaped honeycomb structure portion.

In the pillar shaped honeycomb structure 200, the plurality of cells 208a, 208b are classified into a plurality of first cells 208a which are provided on an inner peripheral side of the outer peripheral side wall 202 and extend from the first end face 204 to the second end face 206, and in which the first end face 204 is open and the second end face 206 has plugged portions 209, and a plurality of second cells 208b which are provided on the inner peripheral side of the outer peripheral side wall 202, extend from the first end face 204 to the second end face 206, and have plugged portions 209 at the first end face 204, and in which the second end face 206 is open. In this pillar shaped honeycomb structure 200, the first cells 208a and the second cells 208b are alternately arranged so as to be close to each other across the partition walls 212.

When an exhaust gas containing particulate matter (PM) such as soot is fed to the upstream first end face 204 of the pillar shaped honeycomb structure 200, the exhaust gas is introduced into the first cells 208a and travels downstream in the first cells 208a. Because the first cell 208a has a plugged portion 209 on the downstream second end face 206, the exhaust gas flows into the second cells 208b through the partition walls 212 that define the first cells 208a and the second cells 208b. The particulate matter (PM) cannot pass through the partition walls 212, so that it is collected and deposited in the first cells 208a. After the particulate matter (PM) has been removed, a clean exhaust gas that flows into the second cells 208b proceeds downstream in the second cells 208b and flows out of the second end face 206 on the downstream side.

Although end face shapes of the pillar shaped honeycomb structures 100, 200 are not limited, but they can be, for example, round shapes such as circular, elliptical, racetrack, and oval shapes, polygonal shapes such as triangular and quadrangular shapes, and other irregular shapes. The illustrated pillar shaped honeycomb structures 100, 200 have a circular end face shape and are cylindrical as a whole.

A height of the pillar shaped honeycomb structure (a length from the first end face to the second end face) is not particularly limited, and may be appropriately set according to an application and required performance. There is also no particular limitation on a relationship between the height of the pillar shaped honeycomb structure and a maximum diameter of each end face (which refers to a maximum length among diameters passing through a center of gravity of each end face of the pillar shaped honeycomb structure). Therefore, the height of the pillar shaped honeycomb structure may be longer than the maximum diameter of each end face, or the height of the pillar shaped honeycomb structure may be shorter than the maximum diameter of each end face.

A material making up the partition walls and the outer peripheral side wall of the pillar shaped honeycomb structure may include, for example, ceramics, although not limited thereto. Examples of the ceramics include cordierite, mullite, zirconium phosphate, aluminum titanate, cordierite-silicon carbide composite, zirconia, spinel, indialite, sapphirine, corundum, titania, and silicon nitride. These ceramics may contain one kind alone, or may contain two or more kinds simultaneously.

In a preferred embodiment, the partition walls are formed of ceramics containing 90% by mass or more of cordierite. This means that a total mass ratio of cordierite (2MgO·2Al₂O₃·5SiO₂) in 100% by mass of a material making up the partition walls is 90% by mass or more. A mass ratio of the cordierite in 100% by mass of the material making up the partition walls is more preferably 95% by mass or more, and even more preferably 99% by mass or more. 100% by mass of the material making up the partition walls can also be cordierite, excluding unavoidable impurities.

An average thickness of the partition walls in the pillar shaped honeycomb structure is preferably 50 μm or more from a viewpoint of ensuring strength, more preferably 60 μm or more, and even more preferably 70 μm or more. Further, the average thickness of the partition walls is preferably 150 μm or less from a viewpoint of suppressing pressure loss, more preferably 130 μm or less, and even more preferably 100 μm or less. Further, the thickness of the partition walls as used herein refers to a length of a line segment L across the partition wall when the centers of gravity C of adjacent cells are connected by the line segment L in a cross section orthogonal to the extending direction of the cells (height direction of the pillar honeycomb structure). The thickness direction D of the partition walls refers to a direction parallel to the line segment L. The average thickness of the partition walls refers to an average value of thicknesses of all the partition walls.

In the pillar shaped honeycomb structure, the partition walls can be porous. When a porosity (%) of the pillar shaped honeycomb structure is measured, an average porosity of each partition wall is preferably 30% or more from a viewpoint of reducing a weight of the pillar shaped honeycomb structure, and more preferably 70% or less from a viewpoint of ensuring strength of the pillar shaped honeycomb structure.

As used herein, an average pore diameter of the partition walls means a median diameter (D50) of a pore diameter measured by a mercury intrusion method defined in JIS R1655: 2003 using a mercury porosimeter. The mercury intrusion method is a method in which a sample is immersed in mercury in a vacuum state, uniform pressure is applied, mercury is intruded into the sample while gradually increasing pressure, and a pore diameter distribution is calculated from the pressure and a volume of mercury intruded into the pores. When the pressure is gradually increased, mercury is intruded into pores in order from pores with a large diameter, and a cumulative volume of mercury increases, and finally, when all the pores are filled with mercury, the cumulative volume reaches equilibrium. A cumulative volume at this time is defined as a total pore volume (cm³/g), and a pore diameter (D50) at a point when mercury having a volume of 50% of the total pore volume is intruded is defined as an average pore diameter.

There is no limitation on an opening shape of the cells in a cross section orthogonal to the extending direction of the cells, but it is preferably a quadrangular shape, hexagonal shape, octagonal shape, or a combination thereof. Among these, the quadrangular shape and hexagonal shape are preferred. By making the opening shape of the cells in this way, a pressure loss when an exhaust gas is allowed to flow through the honeycomb structure is reduced, resulting in improved purification performance when used as a filter. By making the opening shape of the cells in this way, a pressure loss when a fluid is allowed to flow through the pillar shaped honeycomb structure is reduced, resulting in improved purification performance of a catalyst.

A cell density (a number of cells per unit cross-sectional area) in the pillar shaped honeycomb structure is not particularly limited, and it can be, for example, 6 to 2000 cells/square inch (0.9 to 311 cells/cm²), and more preferably 50 to 1000 cells/square inch (7.8 to 155 cells/cm²). Here, the cell density is calculated by dividing a number of cells possessed by the pillar shaped honeycomb structure by an area of one end face of the pillar shaped honeycomb structure excluding the outer peripheral side wall.

When the pillar shaped honeycomb structure is used as a catalyst support, a catalyst layer can be formed on a surface of the partition walls depending on a purpose. Examples of the catalyst include, but are not limited to, an oxidation catalyst (DOC) for oxidatively combusting hydrocarbon (HC) and carbon monoxide (CO) to increase an exhaust gas temperature, a PM combustion catalyst for assisting combustion of PM such as soot, an SCR catalyst and an NSR catalyst for removing nitrogen oxides (NOx), and a three-way catalyst capable of simultaneously removing hydrocarbon (HC), carbon monoxide (CO), and nitrogen oxides (NOx). The catalyst can, for example, appropriately contain precious metals (Pt, Pd, Rh, or the like), alkali metals (Li, Na, K, Cs, or the like), alkaline earth metals (Mg, Ca, Ba, Sr, or the like), rare earths (Ce, Sm, Gd, Nd, Y, La, Pr, or the like), transition metals (Mn, Fe, Co, Ni, Cu, Zn, Sc, Ti, Zr, V, Cr, or the like), or the like.

### <2. Method for Producing Pillar Shaped Honeycomb Structure>

The method for producing the pillar shaped honeycomb structure is illustrated below. First, a raw material composition containing a ceramic raw material, a dispersion medium, a pore former, and a binder is kneaded to produce a green body, and then the green body is extruded and dried to produce a pillar shaped honeycomb formed body. Additives such as a dispersant can be blended in the raw material composition as necessary. For the extrusion, a die having a desired overall shape, cell shape, partition wall thickness, cell density and the like can be used.

In the drying step, for example, known drying methods such as hot air drying, microwave drying, dielectric drying, drying under reduced pressure, drying in vacuum, and freeze drying can be used. Among these, a drying method that combines the hot air drying with the microwave drying or dielectric drying is preferable because the entire formed body can be rapidly and uniformly dried. The plugged portions can be formed by forming plugged portions at predetermined positions on both end faces of a dried honeycomb formed body and then drying the plugged portions.

The ceramic raw material is a raw material for a portion that remains after firing of a metal oxide and a metal or the like, and forms a framework of a pillar shaped honeycomb formed body (pillar shaped honeycomb structure) after firing as ceramics. The ceramic raw material can be provided, for example, in a powder form. Examples of the ceramic raw material include raw materials for obtaining ceramics such as cordierite, mullite, zircon, aluminum titanate, zirconia, spinel, indialite, sapphirine, corundum, and titania. Specifically, examples include, but not limited to, silica, talc, alumina, kaolin, serpentine, pyrophyllite, brucite, boehmite, mullite, magnesite, and aluminum hydroxide. The ceramic raw material may be used alone, or in combination with two or more kinds.

In the case of filter applications such as DPFs and GPFs, cordierite can be suitably used as the ceramics. In this case, a cordierite-forming raw material can be used as the ceramic raw material. The cordierite-forming raw materials are raw materials that will form cordierite by firing. The cordierite-forming raw materials may preferably be comprised of a chemical composition of 30 to 45% by mass of alumina (Al₂O₃) (including the proportion of aluminum hydroxide that is converted to alumina), 11 to 17% by mass of magnesia (MgO) and 42 to 57% by mass of silica (SiO₂).

Examples of the dispersion medium include water or a mixed solvent of water and an organic solvent such as alcohol, and more preferably water.

The pore former is not particularly limited as long as it forms pores after firing, and examples include wheat flour, starch, foamed resin, water-absorbing resin, silica gel, ceramic balloon, polyethylene, polystyrene, polypropylene, nylon, polyester, acrylic, and phenol. The pore former may be used alone, or in combination with two or more kinds. From a viewpoint of increasing a porosity of the honeycomb structure, a content of the pore former is preferably 0.5 parts by mass or more with respect to 100 parts by mass of the ceramic raw material, more preferably 2 parts by mass or more, and even more preferably 3 parts by mass or more. From a viewpoint of ensuring the strength of the honeycomb structure, the content of the pore former is preferably 10 parts by mass or less with respect to 100 parts by mass of the ceramic raw material, more preferably 7 parts by mass or less, and even more preferably 4 parts by mass or less. From a viewpoint of reducing a variation in porosity while refining a pore diameter, it is preferable to use a fine pore former having a median diameter (D50) close to an average pore diameter of the target partition walls, for example, 5 to 25 μm.

Examples of the binder include organic binders such as methyl cellulose, hydroxypropyl cellulose, hydroxyethyl cellulose, carboxymethyl cellulose, and polyvinyl alcohol. In particular, it is preferable to use methyl cellulose in combination with hydroxypropyl cellulose. From a viewpoint of increasing the strength of the honeycomb structure before firing, a content of the binder is preferably 4 parts by mass or more with respect to 100 parts by mass of the ceramic raw material, more preferably 5 parts by mass or more, and even more preferably 6 parts by mass or more. From a viewpoint of suppressing the cracking due to abnormal heat generation in the firing step, the content of the pore former is preferably 9 parts by mass or less with respect to 100 parts by mass of the ceramic raw material, more preferably 8 parts by mass or less, and even more preferably 7 parts by mass or less. The binder may be used alone, or in combination with two or more kinds.

As a dispersant, ethylene glycol, dextrin, fatty acid soaps, polyether polyol, and the like can be used. The dispersant may be used alone or in combination of two or more kinds. The content of the dispersant is preferably 0 to 2 parts by mass with respect to 100 parts by mass of ceramic powder.

As shown in FIGS. 1 and 2, the pillar shaped honeycomb formed body may have both ends of all the cells open. In addition, as shown in FIGS. 3 and 4, the pillar shaped honeycomb formed body can also have a cell structure in which one end of the cells is alternately plugged. A method for plugging the end faces of the pillar shaped honeycomb formed body is not particularly limited, and a known technique can be employed.

A material of the plugged portions is not particularly limited, but it may preferably be ceramics from viewpoints of strength and heat resistance. The ceramics are preferably ceramics containing at least one selected from the group consisting of cordierite, mullite, zircon, aluminum titanate, zirconia, spinel, indialite, sapphirine, corundum, and titania. The plugged portions are preferably formed of a material containing these ceramics in a total of 50% by mass or more, and more preferably formed of a material containing 80% by mass or more. It is even more preferable that the plugged portions have the same material composition as a main body portion of the honeycomb formed body, because an expansion rate during firing can be made the same, leading to improved durability.

A method for forming the plugged portions will be illustrated. A plugging slurry is stored in a storage container. Next, a mask having an opening at a position corresponding to cells in which the plugged portions are to be formed is attached to one end face. An end face to which the mask is attached is immersed in the storage container, and the opening is filled with the plugging slurry to form the plugged portions. The plugged portions can also be formed in a similar manner for the other end face.

The pillar shaped honeycomb structure can be produced by performing a degreasing step and a firing step on the pillar shaped honeycomb formed body after drying. Conditions for the degreasing step and the firing step may be known conditions adopted according to a material composition of the honeycomb formed body and do not require any particular explanation, but examples of specific conditions are given below.

The degreasing step will be described. The degreasing step may be performed by heating the honeycomb formed body at a temperature in a range of about 200 to 1000° C. A heating time is not particularly limited, but it is typically about 10 to 100 hours. The honeycomb formed body after undergoing the degreasing step is referred to as a calcined body.

The firing step can be performed, for example, by heating the calcined body to a maximum temperature according to the material in an air atmosphere and holding for 3 to 10 hours, although it depends on a material composition of the honeycomb formed body.

The method for producing a ceramic product according to the present embodiment includes adjusting a water vapor partial pressure in a firing furnace when firing a subsequent ceramic product using at least one result of a water absorption rate and a compressive strength that are characteristics of a previously fired ceramic product. The adjustment of the water vapor partial pressure is performed in the firing step described above. By adopting such a configuration, characteristics of the ceramic product can be adjusted by a parameter different from a firing temperature. It is also considered that a sintering promoting effect (an effect of promoting a surface diffusion rate) can be obtained by increasing a water vapor partial pressure in a firing process. Therefore, by controlling the water vapor partial pressure, characteristics of the ceramic product can be controlled without changing a raw material composition or a firing temperature. For this reason, an increase in the water vapor partial pressure also allows the firing temperature to be lowered as compared to conventional methods, and allows energy to be saved and CO₂ emissions to be reduced, and allows defects in the ceramic product due to melting or discoloration to be suppressed.

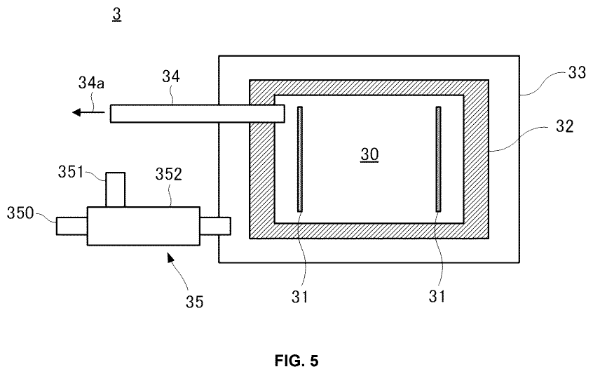

The water vapor partial pressure may be adjusted by various methods. FIG. 5 shows an example of a method for adjusting the water vapor partial pressure. The firing furnace may be an electric furnace 3 shown in FIG. 5. The electric furnace 3 has a placing space 30 on which a ceramic product to be fired is placed, and an electric heater 31 that is disposed in the placing space 30 and generates heat by electrical conduction. The placing space 30 is surrounded by a box-shaped thermal insulation board 32, and the thermal insulation board 32 is surrounded by a housing 33. A discharge pipe 34 is connected to the placing space 30 to discharge a gas 34a generated during firing of the ceramic product. To a space between the thermal insulation board 32 and the housing 33, a water vapor feeder 35 is connected. The water vapor feeder 35 has an air feeder 350, a water feed pipe 351, and a heating device 352. An air feed source (not shown) is connected to the air feeder 350, and air from the air feed source is fed to the heating device 352 through the air feeder 350. Similarly, a water feed source (not shown) is connected to the water feed pipe 351, and water from the water feed source is fed to the heating device 352 through the water feed pipe 351. The heating device 352 heats the water to generate water vapor, and the water vapor is fed by air to the space between the thermal insulation board 32 and the housing 33. The water vapor enters the placing space 30 through an opening provided in the thermal insulation board 32. By adjusting an amount of water vapor from the water vapor feeder 35, the water vapor partial pressure in the electric furnace 3 can be adjusted. In such a configuration, water can be vaporized in advance before being introduced into the furnace, and the water vapor partial pressure can be controlled to be any water vapor partial pressure in any temperature range.

Alternatively, the firing furnace may be a gas combustion furnace that burns a gas. The water vapor partial pressure in the combustion furnace can be adjusted by a type of gas to be combusted and an amount of agitation air to be fed. An amount of water vapor generated during theoretical combustion varies depending on a type of gas. As the gas, a methane gas, hydrogen gas and ammonia gas can be used. A water vapor partial pressure during theoretical combustion of the methane gas is 18% at maximum, a water vapor partial pressure during theoretical combustion of the hydrogen gas is 33% at maximum, and a water vapor partial pressure during theoretical combustion of the ammonia gas is 30% at maximum. In the case of the gas combustion furnace, it is not necessary to add the water vapor feeder 35 and equipment for controlling the water vapor feeder 35 as in the above-described electric furnace 3, so that equipment can be simplified. Further, in the gas combustion furnace, a combustion gas has agitation capability in the furnace, so that a temperature distribution in the furnace and a water vapor distribution can also be made uniform. In particular, by using the hydrogen gas that generates a large amount of water vapor during combustion, the water vapor partial pressure in the furnace can be efficiently adjusted. Furthermore, by using the hydrogen gas, it is possible to eliminate carbon dioxide emissions derived from fossil fuels such as natural gas, and this is also environmentally friendly. Moreover, by changing the firing furnace from the electric furnace 3 to the gas combustion furnace, an energy source for changing an amount of water vapor contained in a firing atmosphere can be changed from electricity to gas. In addition, it is also effective for conversion of a fuel source from natural gas to the hydrogen gas or ammonia gas.

In the method for producing a ceramic product according to the present embodiment, the method further includes a step of obtaining, from at least one result of a water absorption rate and a compressive strength that are characteristics of a previously fired ceramic product, at least one relational expression of a relational expression between the water absorption rate and the water vapor partial pressure and a relational expression between the compressive strength and the water vapor partial pressure, and the water vapor partial pressure in the firing furnace when firing a subsequent ceramic product is adjusted using the at least one relational expression. By using the relational expression, characteristics of the ceramic product can be adjusted more reliably. The relational expression can be obtained by, for example, firing ceramic products while changing the water vapor partial pressure for each predetermined unit such as for each lot, and investigating characteristics of those ceramic products.

It is preferable to obtain the at least one relational expression for each material of the ceramic product. This is because a relationship between the water vapor partial pressure and the characteristics may change for each material.

When a material of the ceramic product is an oxide-based material, and the water absorption rate is Y and the water vapor partial pressure is X, a relational expression between the water absorption rate and the water vapor partial pressure may be organized as follows:

$$Y = - c * X + d ,$$

in which c and d are variables (positive numbers) determined by a composition of the oxide-based material. As will be described in Examples below, it has been confirmed that when the material of the ceramic product is the oxide-based material, the water absorption rate of the ceramic product decreases as the water vapor partial pressure is increased.

When a material of the ceramic product is the oxide-based material, and the compressive strength is A and the water vapor partial pressure is X, a relational expression between the compressive strength and the water vapor partial pressure may be organized as follows:

$$A = e * X + f ,$$

in which e and f are variables (positive numbers) determined by a composition of the oxide-based material. As will be described in Examples below, it has been confirmed that when the material of the ceramic product is the oxide-based material, the compressive strength of the ceramic product increases as the water vapor partial pressure is increased.

Additionally or alternatively, the method for firing the ceramic product according to the present embodiment is a method for firing a ceramic product having a raw material composition that does not involve carbon-derived heat generation when an atmosphere temperature in a firing furnace is 700° C. or more, and includes adjusting a water vapor partial pressure in the firing furnace when firing a subsequent ceramic product using at least one result of a dimension and a porosity that are characteristics of a previously fired ceramic product. Whether or not the raw material composition does not involve carbon-derived heat generation when the atmosphere temperature in the firing furnace is 700° C. or more can be determined based on the raw material composition before firing. More specifically, it can be determined based on carbon contained in the raw material before firing. When carbon contained in the raw material is mainly crystalline carbon (for example, graphite or coke), carbon-derived heat generation is involved when the atmosphere temperature in the firing furnace is 700° C. or more. In contrast, when carbon contained in the raw material is non-crystalline carbon (for example, carbon black or activated carbon), the carbon contained in the raw material burns out at about 400 to 500° C. even when an oxygen concentration in the firing furnace is lower (for example, 10%). If an oxygen concentration in the firing furnace is extremely low (for example, 3%), there is a possibility that carbon contained in the raw material remains without being oxidized even at 700° C., but at such an oxygen concentration, carbon-derived heat generation is very small or does not occur. It should be noted that when the firing furnace is the electric furnace 3 and the interior of the electric furnace 3 is set to an air atmosphere (for example, when oxygen concentration control by feeding a nitrogen gas or argon gas or the like is not performed), an oxygen concentration in the electric furnace 3 is approximately 21%. Whether or not the carbon contained in the raw material is crystalline carbon can be examined by an X-ray diffraction method (XRD).

At this time, the method for firing the ceramic product further includes a step of obtaining, from at least one result of a dimension and a porosity that are characteristics of a previously fired ceramic product, at least one relational expression of a relational expression between the dimension and a water vapor partial pressure and a relational expression between the porosity and the water vapor partial pressure, and the water vapor partial pressure in the firing furnace when firing a subsequent ceramic product is adjusted using the at least one relational expression. It is preferable to also obtain such a relational expression for each material of the ceramic product.

When the material of the ceramic product is the oxide-based material, and a firing ratio, defined by a ratio of a dimension (Db) of the ceramic product before firing to a dimension (Da) of the ceramic product after firing, is S(=Db/Da), and the water vapor partial pressure is X, a relational expression between the firing ratio and the water vapor partial pressure may be organized as follows:

$$S = g * X + h$$

in which g and h are variables (positive numbers) determined by a composition of the oxide-based material. As will be described in Examples below, it has been confirmed that when the material of the ceramic product is the oxide-based material, the firing ratio of the ceramic product increases as the water vapor partial pressure is increased.

When the material of the ceramic product is the oxide-based material, and a porosity is K and the water vapor partial pressure is X, a relational expression between the porosity and the water vapor partial pressure may be organized as follows:

$$K = - a * X + b$$

in which a and b are variables (positive numbers) determined by a composition of the oxide-based material. As will be described in Examples below, it has been confirmed that when the material of the ceramic product is the oxide-based material, the porosity of the ceramic product decreases as the water vapor partial pressure is increased.

As used herein, the oxide-based material means a ceramic material that does not contain carbon atoms and is formed by chemical bonding of oxygen and other elements. Examples of the oxide-based material include aluminum oxide (Al₂O₃), zirconium oxide (ZrO₂), mullite (3Al₂O₃·2SiO₂), and cordierite (2MgO·2Al₂O₃·5SiO₂). The oxide-based material has an improved heat resistance, corrosion resistance and mechanical strength, and is used in a wide variety of applications such as electronic components, medical devices, cutting tools, refractory materials, and environmental purification.

The water vapor partial pressure in the firing furnace when firing the subsequent ceramic product may be 33% or less. The water vapor partial pressure of 33% or less allows characteristics of the ceramic product to be adjusted more reliably.

Change adjustment of the water vapor partial pressure is performed when a firing temperature in the firing furnace is 600° C. or more and a maximum temperature or less. By performing change adjustment of the water vapor partial pressure at such timing, characteristics of the ceramic product can be adjusted more reliably. More specifically, when the relational expression is obtained as described above, a target water vapor partial pressure for obtaining target characteristics of the ceramic product is calculated from the relational expression, and when a firing temperature in the firing furnace is 600° C. or more and a maximum temperature or less, change adjustment of the water vapor partial pressure in the firing furnace is performed so that the water vapor partial pressure in the firing furnace becomes the target water vapor partial pressure. The firing temperature is an atmosphere temperature around the ceramic product (object to be fired) in the firing furnace. The firing temperature is measured by a thermometer disposed around the ceramic product in the firing furnace. In firing the ceramic product, a set temperature of the firing furnace is adjusted so that an atmosphere temperature around the ceramic product in the firing furnace becomes a target temperature. A maximum temperature of the firing temperature varies depending on a ceramic raw material used in the ceramic product. For example, when the ceramic raw material is alumina, the maximum temperature is 1350° C. to 1600° C., when the ceramic raw material is zirconia, the maximum temperature is 1350° C. to 1450° C., when the ceramic raw material is magnesia, the maximum temperature is 1500° C. to 1750° C., when the ceramic raw material is cordierite, the maximum temperature is 1350° C. to 1550° C., and when the ceramic raw material is mullite, the maximum temperature is 1500° C. to 1600° C. When the firing temperature is less than 600° C., the water vapor partial pressure may be left in an air state without specially controlling the water vapor partial pressure.

It is preferable that a ratio of an organic material in a raw material of the ceramic product is 20% by mass or less. The organic material is contained in the dispersion medium, pore former and binder as described above.

While the preferred embodiments of the invention have been described above in detail with reference to the drawings, the present invention is not limited to such embodiments. It is obvious that a person skilled in the art to which this invention belongs can arrive at various variations or modifications in the scope of the technical idea recited in the claims, and it is understood that they also belong to the technical scope of this invention.

### Examples

The invention will be more specifically described by means of the following Examples. The invention is not limited to these examples.

The present inventors prepared green bodies (materials A to C) by mixing and kneading a cordierite-forming raw material, a pore former, a binder, and a dispersant at ratios shown in Table 1 below. As the cordierite-forming raw material, talc, kaolin, alumina, aluminum hydroxide, and silica were used. As the pore former, a polyacrylic acid-based polymer was used, as the binder, hydroxypropyl methylcellulose was used, and as the dispersant, a fatty acid soap was used.

TABLE 1

| | Cordierite-Forming Raw Materials | | | | | | | |
|---|---|---|---|---|---|---|---|---|
| | | | | Aluminum | | Pore | | |
| Materials | Talc | Kaolin | Alumina | Hydroxide | Silica | Former | Binder | Dispersant |
| A | 40 | 15 | 30 | 0 | 15 | 3 | 6 | 1 |
| B | 40 | 20 | 15 | 15 | 10 | 2 | 6 | 1 |
| C | 40 | 45 | 15 | 0 | 0 | 0 | 6 | 1 |

These green bodies were fed into an extrusion molding machine and extruded in a horizontal direction through a predetermined die to obtain a cylindrical honeycomb formed body. After the obtained honeycomb formed body was subjected to dielectric drying and hot air drying, both end faces were cut to have predetermined dimensions to obtain a cylindrical honeycomb formed body.

The obtained cylindrical honeycomb formed body was heated and degreased at 200° C. for 8 hours in an air atmosphere and further fired at 1430° C. for 4 hours in an air atmosphere to obtain a pillar shaped honeycomb structure as a ceramic product. Specifications of the obtained pillar shaped honeycomb structure are as follows:
Overall shape: cylindrical with a diameter of 118 mm×a height of 91 mm;
Cell shape in a cross section perpendicular to a flow path direction of the cells: square;
Cell density (number of cells per unit cross-sectional area): 750 cells/square inch; and
Average thickness of partition walls: 2.6 mil (66 μm) (nominal value based on specifications of the die).

An electric furnace as shown in FIG. 5 was used for firing, and a water vapor partial pressure during firing was adjusted in a range of 0% or more and 33% or less using a water vapor feeder connected to the electric furnace. The 33% assumes a water vapor partial pressure when a hydrogen gas is theoretically combusted. Adjustment of the water vapor partial pressure (introduction of water vapor into the electric furnace) was performed when a firing temperature in the firing furnace was 600° C. or more and a maximum temperature or less.

A water absorption rate, a compressive strength, a dimension, and a porosity of the obtained ceramic product were measured.

### <Method for Measuring Water Absorption Rate>

Measurement was performed in accordance with automotive standard JASO M 505-87 issued by the Society of Automotive Engineers of Japan, Inc.

### <Method for Measuring Compressive Strength>

Measurement was performed in accordance with automotive standard JASO M 505-87 issued by the Society of Automotive Engineers of Japan, Inc.

### <Method for Measuring Dimension>

A dimension in a length direction (a dimension between end faces in an extending direction of cells) of the honeycomb formed body (ceramic product before firing) was measured by a digital height gauge. Similarly, a dimension in a length direction of the pillar shaped honeycomb structure (ceramic product after firing) was measured by a digital height gauge. Then, a firing ratio, defined by a ratio of the dimension of the honeycomb formed body to the dimension of the pillar shaped honeycomb structure.

### <Method for Measuring Porosity>

Measurement was performed by a mercury intrusion method using Micromeritics model Autopore 9505.

### <Measurement Results of Water Absorption Rate>

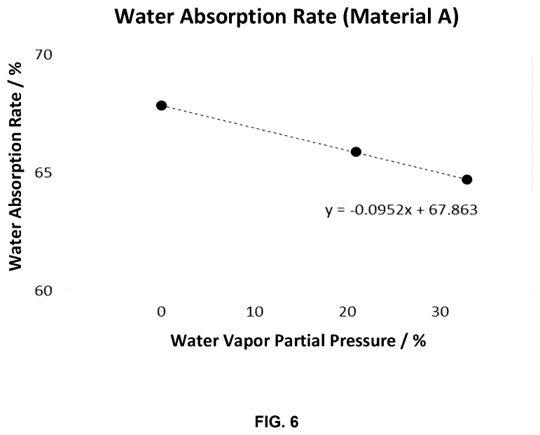

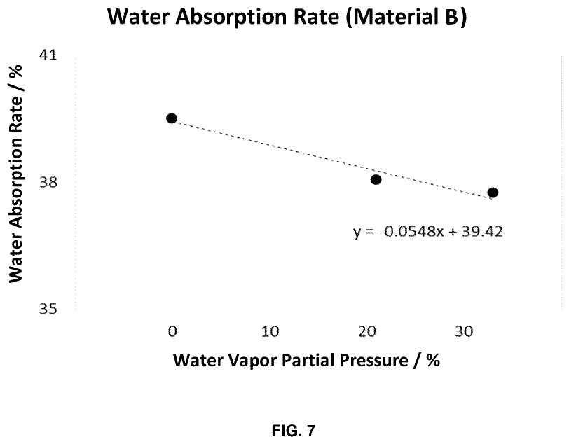

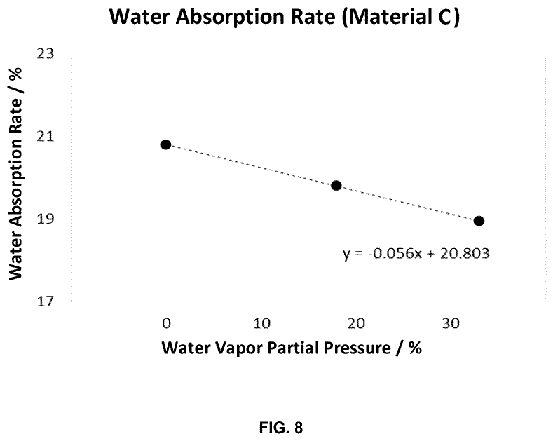

FIGS. 6 to 8 are graphs showing a relationship between a water absorption rate and a water vapor partial pressure during firing for pillar shaped honeycomb structures using the materials A to C. As can be seen from the graphs of FIGS. 6 to 8, it was confirmed that a water absorption rate of the pillar shaped honeycomb structure could be adjusted by adjusting a water vapor partial pressure during firing.

Further, it was confirmed that the water absorption rate of the pillar shaped honeycomb structure decreased as the water vapor partial pressure during firing increased. That is, it was confirmed that when the water absorption rate was Y and the water vapor partial pressure was X, a relational expression between the water absorption rate and the water vapor partial pressure could be organized as follows:

$$Y = - c * X + d$$

In material A, c=0.0952 and d=67.863; in material B, c=0.0548 and d=39.42; in material C, c=0.056 and d=20.803.

### <Measurement Results of Compressive Strength>

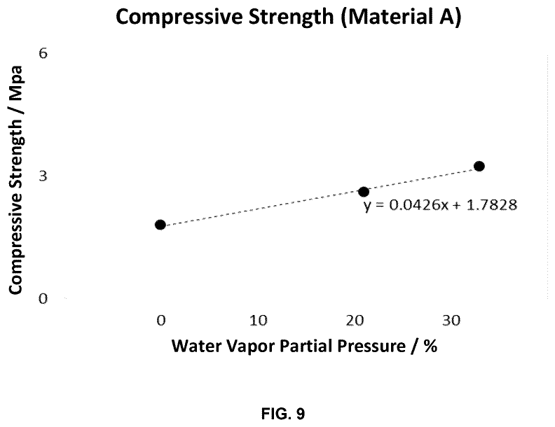

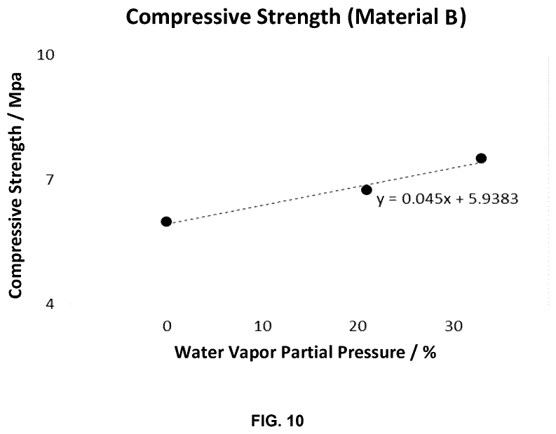

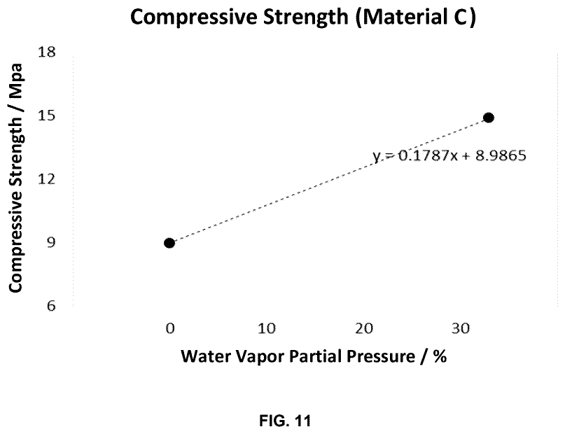

Next, FIGS. 9 to 11 are graphs showing a relationship between a compressive strength and a water vapor partial pressure during firing for pillar shaped honeycomb structures using the materials A to C. As can be seen from the graphs of FIGS. 9 to 11, it was confirmed that a compressive strength of the pillar shaped honeycomb structure could be adjusted by adjusting a water vapor partial pressure during firing.

Further, it was confirmed that the compressive strength of the pillar shaped honeycomb structure increased as the water vapor partial pressure during firing increased. That is, it was confirmed that when the compressive strength was A and the water vapor partial pressure was X, a relational expression between the compressive strength and the water vapor partial pressure could be organized as follows:

$$A = e * X + f$$

In material A, e=0.0426 and f=1.7828; in material B, e=0.045 and f=5.9383; in material C, e=0.1787 and f=8.9865.

### <Measurement Results of Dimension>

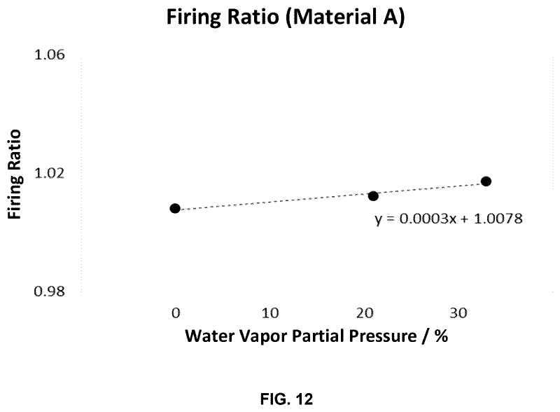

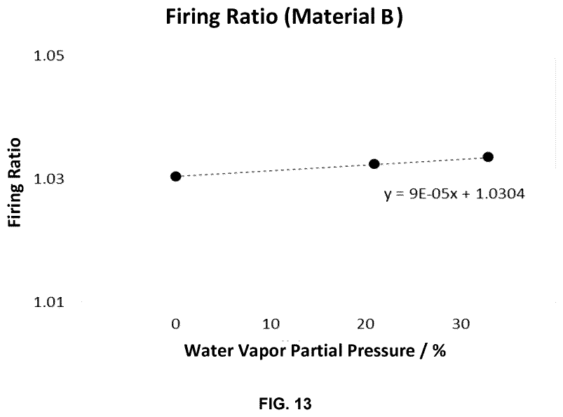

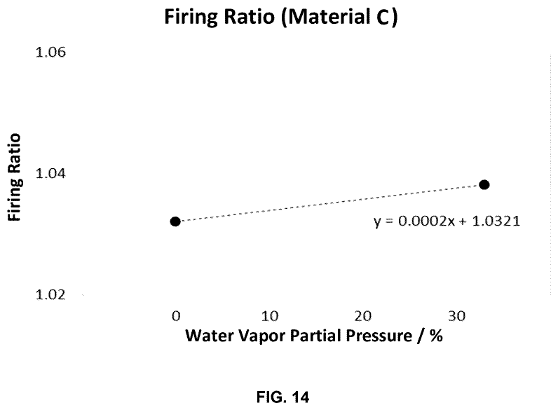

Next, FIGS. 12 to 14 are graphs showing a relationship between a firing ratio (dimension) and a water vapor partial pressure during firing for pillar shaped honeycomb structures using the materials A to C. As can be seen from the graphs of FIGS. 12 to 14, it was confirmed that the firing ratio of the pillar shaped honeycomb structure could be adjusted by adjusting a water vapor partial pressure during firing.

Further, it was confirmed that the firing ratio of the pillar shaped honeycomb structure increased as the water vapor partial pressure during firing increased. That is, it was confirmed that when the firing ratio was S and the water vapor partial pressure was X, a relational expression between the firing ratio and the water vapor partial pressure could be organized as follows:

$$S = g * X + h$$

In material A, g=0.0003 and h=1.0078, and in material B, g=9*10⁻⁵ and h=1.0304, and in material C, g=0.0002 and h=1.0321.

### <Measurement Results of Porosity>

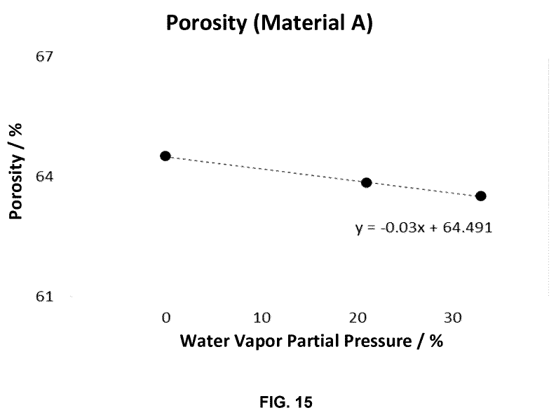

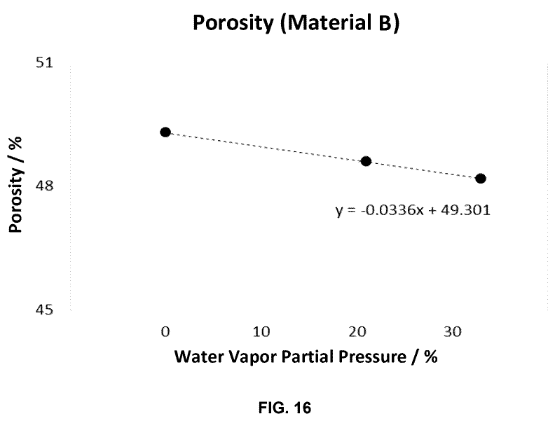

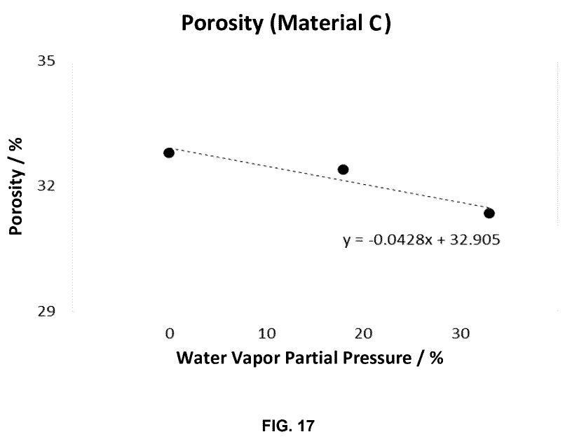

FIGS. 15 to 17 are graphs showing a relationship between a porosity and a water vapor partial pressure during firing in pillar shaped honeycomb structures using materials A to C. As can be seen from the graphs of FIGS. 15 to 17, it was confirmed that the porosity of the pillar shaped honeycomb structure could be adjusted by adjusting a water vapor partial pressure during firing.

Further, it was confirmed that the porosity of the pillar shaped honeycomb structure decreased as a water vapor partial pressure during firing increased. That is, it was confirmed that when the porosity was K and the water vapor partial pressure was X, a relational expression between the porosity and the water vapor partial pressure could be organized as follows:

$$K = - a * X + b$$

In material A, a=0.03 and b=64.491, in material B, a=0.0336 and b=49.301, and in material C, a=0.0428 and b=32.905.

### <Appendix>

In addition, the following inventions are included herein:

[1]

A method for firing a ceramic product having a raw material composition that does not involve carbon-derived heat generation when an atmosphere temperature in a firing furnace is 700° C. or more, the method including adjusting a water vapor partial pressure in the firing furnace when firing a subsequent ceramic product using at least one result of a dimension and a porosity that are characteristics of a previously fired ceramic product.

[2]

The method for producing a ceramic product according to [1], further including a step of obtaining, from the at least one result, at least one relational expression of a relational expression between the dimension and the water vapor partial pressure and a relational expression between the porosity and the water vapor partial pressure,
wherein the water vapor partial pressure in the firing furnace when firing the subsequent ceramic product is adjusted using the at least one relational expression.
   [3]

The method for producing a ceramic product according to [2], wherein the at least one relational expression is obtained for each material of the ceramic product.

[4]

The method for producing a ceramic product according to [2] or [3], wherein, when a material of the ceramic product is an oxide-based material, and a firing ratio, defined by a ratio of a dimension (Db) of the ceramic product before firing to a dimension (Da) of the ceramic product after firing, is S(=Db/Da), and the water vapor partial pressure is X, a relational expression between the firing ratio and the water vapor partial pressure is as follows:

$$S = g * X + h$$

in which g and h are variables determined by a composition of the oxide-based material.
[5]

The method for producing a ceramic product according to any one of [2] to [4], wherein, when a material of the ceramic product is an oxide-based material, and the porosity is K and the water vapor partial pressure is X, a relational expression between the porosity and the water vapor partial pressure is as follows:

$$K = - a * X + b ,$$

in which a and b are variables determined by a composition of the oxide-based material.
[6]

The method for producing a ceramic product according to any one of [1] to [5], wherein a water vapor partial pressure in the firing furnace when firing the subsequent ceramic product is 33% or less.

[7]

The method for producing a ceramic product according to any one of [1] to [6], wherein change adjustment of the water vapor partial pressure is performed when a firing temperature in the firing furnace is 600° C. or more and a maximum temperature or less.

[8]

The method for producing a ceramic product according to any one of [1] to [7], wherein a ratio of an organic material in a raw material of the ceramic product is 20% by mass or less.

The application claims benefit of priority to Japanese Patent Application No 2025-045687 filed on Mar. 19, 2025 with the Japanese Patent Office, the entire contents of which are incorporated herein by reference.

### DESCRIPTION OF REFERENCE NUMERALS

3: electric furnace
30: placing space
31: electric heater
32: thermal insulation board
33: housing
34: discharge pipe
34a: gas
35: water vapor feeder
100: pillar shaped honeycomb structure
102: outer peripheral side wall
104: first end face
106: second end face
108: cell
112: partition wall
200: pillar shaped honeycomb structure
202: outer peripheral side wall
204: first end face
206: second end face
208 a: first cell
208b: second cell
209: plugged portion
212: partition wall
350: air feeder
351: water feed pipe
352: heating device

1. A method for producing a ceramic product, the method comprising adjusting a water vapor partial pressure in a firing furnace when firing a subsequent ceramic product using at least one result of a water absorption rate and a compressive strength that are characteristics of a previously fired ceramic product.

2. The method for producing a ceramic product according to claim 1, further comprising a step of obtaining, from the at least one result, at least one relational expression of a relational expression between the water absorption rate and the water vapor partial pressure and a relational expression between the compressive strength and the water vapor partial pressure,
wherein the water vapor partial pressure in the firing furnace when firing the subsequent ceramic product is adjusted using the at least one relational expression.

3. The method for producing a ceramic product of claim 2, wherein the at least one relational expression is obtained for each material of the ceramic product.

4. The method for producing a ceramic product of claim 3, wherein, when a material of the ceramic product is an oxide-based material, and the water absorption rate is Y and the water vapor partial pressure is X, a relational expression between the water absorption rate and the water vapor partial pressure is as follows:
$$Y = - c * X + d ,$$
in which c and d are variables determined by a composition of the oxide-based material.

5. The method for producing a ceramic product of claim 3, wherein, when a material of the ceramic product is an oxide-based material, and the compressive strength is A and the water vapor partial pressure is X, a relational expression between the compressive strength and the water vapor partial pressure is as follows:
$$A = e * X + f ,$$
in which e and f are variables determined by a composition of the oxide-based material.

6. The method for producing a ceramic product of claim 1, wherein the water vapor partial pressure in the firing furnace when firing the subsequent ceramic product is 33% or less.

7. The method for producing a ceramic product of claim 1, wherein change adjustment of the water vapor partial pressure is performed when a firing temperature in the firing furnace is 600° C. or more and a maximum temperature or less.

8. The method for producing a ceramic product of claim 1, wherein a ratio of an organic material in a raw material of the ceramic product is 20% by mass or less.
